(19) United States
(12) Patent Application Publication
(10) Pub. No.: US 2005/0101209 A1
(43) Pub. Date: May 12, 2005

(54) Woven fabric with moisture management properties

(75) Inventors: Yi Li, Hong Kong (CN); Jun-Yan Hu, Hong Kong (CN)

Correspondence Address: LEYDIG VOIT & MAYER, LTD, 700 THIRTEENTH ST. NW, SUITE 300, WASHINGTON, DC, 20005-3960, US

(73) Assignee: The Hong Kong Polytechnic University, Hung Hom (HK)

(21) Appl. No.: 10/703,087

(22) Filed: Nov. 7, 2003

(51) Int. Cl. B32B 5/02; B32B 5/26; D03D 15/00; D03D 13/00; B32B 27/12; B32B 27/04

(52) U.S. Cl. 442/118; 442/79; 442/203; 442/217

(57) ABSTRACT

A woven fabric consists of a generally uniformly woven structure of hydrophobic and hydrophilic materials and has inner and outer exposed surfaces of hydrophobic and hydrophilic materials. The inner exposed surface is between 40% and 70% hydrophobic material, and the outer exposed surface is predominantly hydrophilic material.

### BACKGROUND TO THE INVENTION

1. Field of the Invention

The invention relates to woven fabrics, and fabric for wicking sweat or moisture away from the skin.

2. Background Information

There is an on-going requirement to make clothing, especially sports clothing, diapers and incontinent apparel and so forth more comfortable and healthier to wear and use, even though considerable moisture or liquids may be liberated by the wearer in normal use. It is known to provide composite textile materials that comprise distinct layers of materials having respective appropriate characteristics so that moisture, or liquid, migrates or drains quickly away from an inner surface of the material in contact with the skin of a wearer. The liquid may be retained in a second outer layer in the case of a diaper or evaporate normally from an outer surface of the material where there is only one layer, in the case of sports clothing, say. Examples of known textile materials can be found in U.S. Pat. Nos. 6,509,285, 6,432,504, 6,427,493, 6,341,505, 6,277,469, 5,315,717, 5,735,145 and 4,411,660.

However difficulties remain especially with multi-layer materials because they are bulky and uncomfortable or certainly difficult to style fashionably. Also, even though the present materials may keep the wearer's skin relatively dry and comfortable in use at first, once an absorbent layer becomes saturated or relatively wet, the moisture or liquid may migrate back towards the body of the user. Presently used composite materials, especially where they are multi-layer, are usually not re-usable.

### SUMMARY OF THE INVENTION

It is an object of the present invention to provide a woven fabric with improved moisture management properties.

According to the invention there is provided a woven fabric comprising a generally uniform woven structure consisting of hydrophobic and hydrophilic materials, the woven structure having an inner exposed surface of hydrophobic and hydrophilic materials that is between 40% and 70% the hydrophobic material, and having an outer exposed surface of hydrophobic and hydrophilic materials that is predominantly the hydrophilic material.

Preferably, the hydrophobic material is polypropylene.

Preferably, the hydrophobic material is polyester.

Preferably, the hydrophobic material is natural fiber selected from cotton, wool, silk and linen, and which are treated with a water repellent agent.

Preferably, the water repellent agent is HYDROPHOBL CF.

Preferably, the water repellent agent is SiOₓ nano water repellence agent.

Preferably, the hydrophilic material is absorbent yarn made from synthetic fiber.

Preferably, the synthetic fiber is coolmax or coolplus.

Preferably, the hydrophilic material is absorbent yarn made from natural fiber.

Preferably, the natural fiber is one of cotton, silk, wool or linen.

Preferably, the natural fiber is treated with a hydrophilic finishing agent with nano particles such as TiO₂ and ZnO for creating nanostructures.

Preferably, the woven fabric structure is one of plain weave, twill weave or sateen weave.

The fabric can be used in components of clothing including sports wear, casual wear, uniform and pants. It can also be used in components of a diaper, or household articles such as bed sheet, covers and pillows.

Further aspects of the invention will become apparent from the following description, which is given by way of example only.

### BRIEF DESCRIPTION OF THE DRAWINGS

Embodiments of the invention will now be described with reference to the accompanying drawings in which:

FIG. 1 illustrates the structure of denim cotton yarn of a woven fabric according to the invention,

FIG. 2 illustrates the structure of polypropylene of a woven fabric according to the invention,

FIG. 3 is a typical measuring curve of the woven fabric,

FIGS. 4 to 11 illustrate how difference percentage points/areas on the inner surface of polypropylenes or coolmax influence the measurement results of one-way transfer of the fabric and over all moisture management properties, and

FIG. 12 is the typical measurement curve of the fabric in which the hydrophobic yarn is pure cotton pre-treated by nano water repellent agent.

### DESCRIPTION OF THE PREFERRED EMBODIMENTS

According to a preferred embodiment of the invention a flat woven fabric with moisture management properties for use in garments includes inner and outer surfaces. The inner surface is, in use, worn next to the skin of a wearer, and has a high proportion of hydrophobic areas or structure points and a low proportion of hydrophilic areas or structure points. In the preferred embodiment the hydrophobic areas occupy 40%-70% of the inner surface. The outer surface, positioned away from the wearers skin, has a high proportion of hydrophilic areas or structure points. The hydrophilic fibers/yarns transfer any liquid or moisture from the inner side of the fabric to the outer side.

The low proportion of hydrophilic points/areas on the inner surface allows quick absorption of liquid water and enable wicking actions, while the high proportion of hydrophobic points/areas on the inner surface is able to keep the surface relatively dry and prevent the liquid water wicking back to the inner surface.

The terms hydrophobic and hydrophilic are comparative terms and depend upon selection of fibers and yarn with different surface tension, contact angle, shape of cross section, diameters of fibers, chemical and physical finishing, and so forth. Thus it will be understood that the terms “hydrophobic” and “hydrophilic” are used in the specification and claims as relative terms. This means that the Woven fabric is made up of materials that are hydrophobic and hydrophilic relative to one another rather than necessarily having such properties in comparison to a norm or some industrial standard, for example.

A wide range of hydrophobic yarns can be selected for the fabric. Such yarns can be synthetic yarns, like polypropylenes, etc., or natural fibers finished with the use of chemicals or nano technology to enhance their hydrophobic properties. Examples include cotton yarns finished by water repellent agent, Ciba's HYDROPHOBL CF, or Zhousan Mingri nano-technology company's water repellent agent. In the preferred embodiment polypropylene is chosen for the hydrophobic yarn.

Likewise, hydrophilic yarns can be selected from a wide range of synthetic yarns or fibers. Examples include coolmax, coolplus, natural yarns/fibers such as cotton, or yarns finished with the use of chemicals or nano technology to modify their hydrophilic properties by hydrophility finishing agent such as FZ agent. In the preferred embodiment coolmax is chosen for the hydrophilic yarn.

The moisture management properties of the fabric depend on the proportion of the hydrophobic areas or points on the inner surface. For polypropylene hydrophobic yarn used with pure cotton hydrophilic yarn the range of polypropylenes structure points on the inner surface should be 40% to 70% for optimum moisture management.

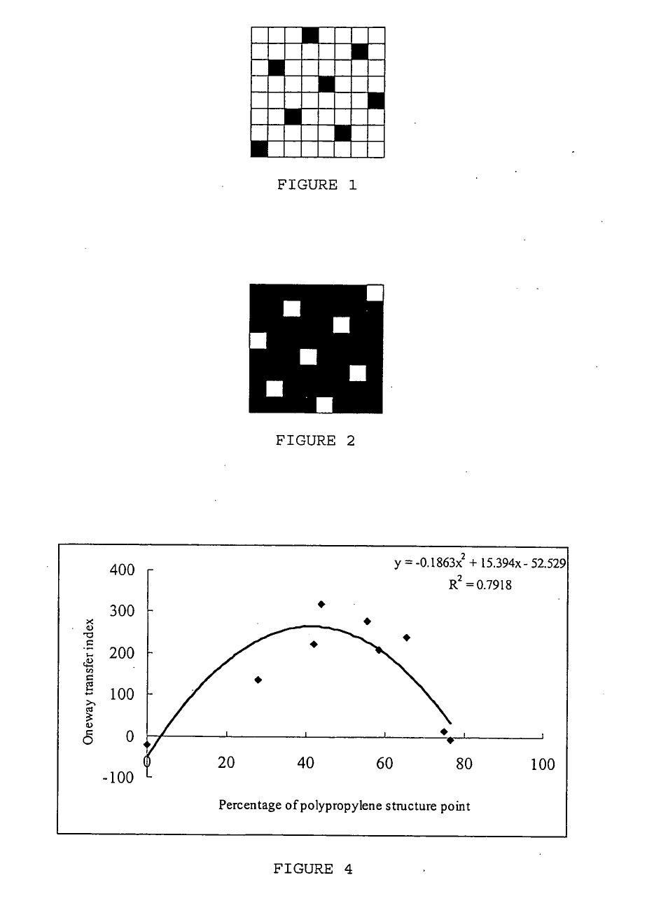

A series of woven fabrics with different percentage of hydrophobic points/areas were developed and measured. As an example, the structure of a fabric, WMMF006, is designed as shown as in FIGS. 1 and 2. The warp yarn is 100D polyester. The structure of the fabric in FIG. 1 is 20S denim cotton yarn, and the structure of the fabric in FIG. 2 is 83.3 dex polypropylene. The pattern arrangement is polypropylene:cotton:polypropylene=1:1:1. The content of fabric is cotton 45%, polypropylene 25%, polyester 30% and the structure is 100D×(20s+83.3 dtex)/55.1 ends/cm×90 ends/cm.

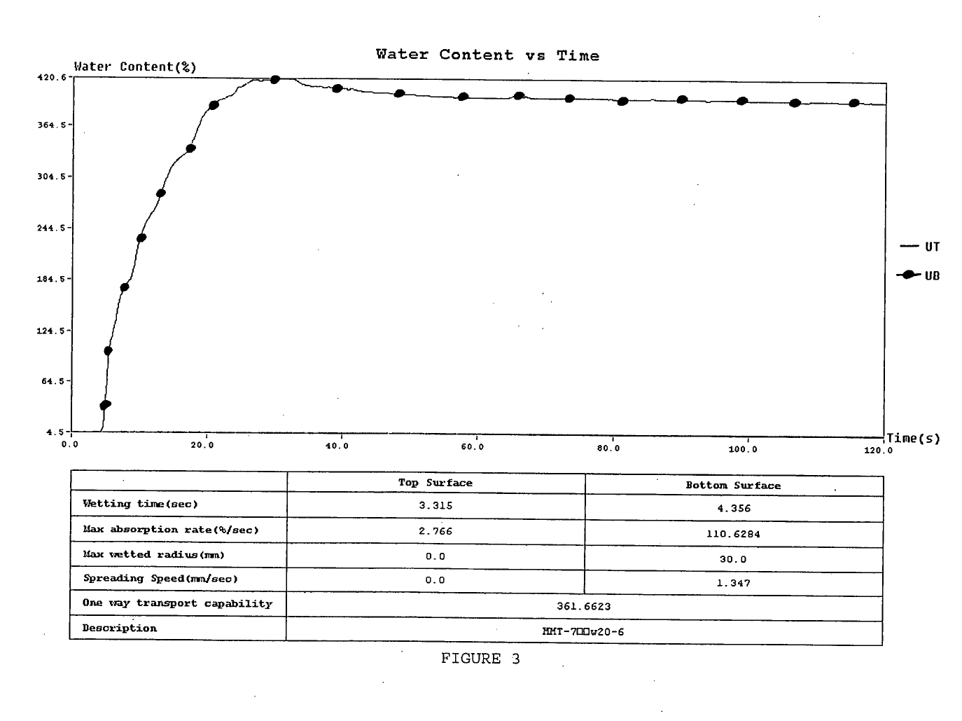

The moisture management properties of the fabric were tested using a moisture management tester to determine moisture management indexes. The fabric is sandwiched between two plates. Electrical conductors arranged in concentric opposing pairs are used to measure changes in electrical resistance of the fabric. A quantity of water (or other chosen liquid) is poured down a guide pipe and changes of resistance measured against time. From this data, specific indexes are determined, in a repeatable fashion, and used for determining moisture management characteristics of the fabric. Details of the tester can be found inventors U.S. Pat. No. 6,499,338. The typical measuring curve of the woven fabric is shown in FIG. 3.

FIG. 4 shows the influence of percentage of inner surface structure points of polypropylenes on the fabric one way transfer property.

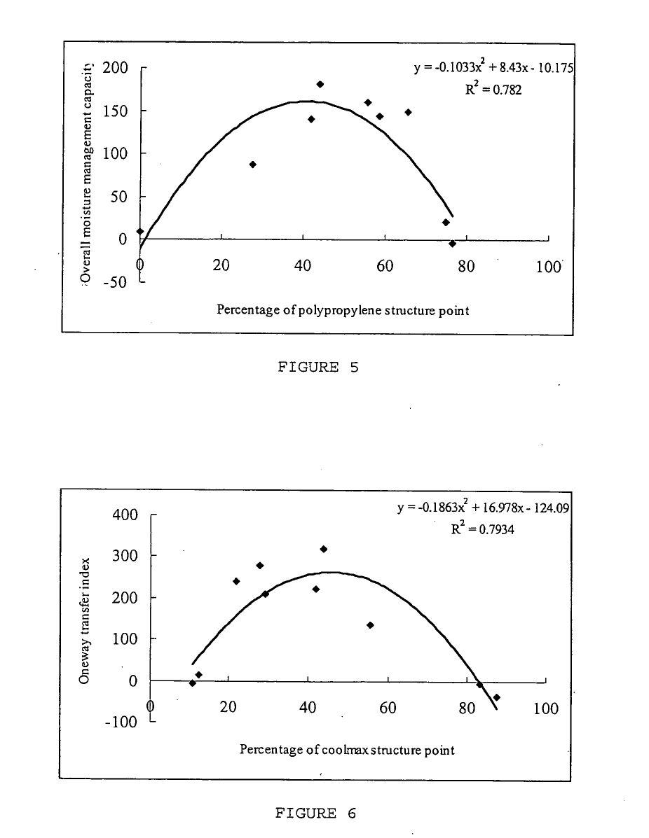

FIG. 5 shows the influence of percentage of inner surface structure point of polypropylenes on the fabric overall moisture management capacity.

FIG. 6 shows the influence of percentage of inner surface structure point of coolmax on the fabric one way transfer property.

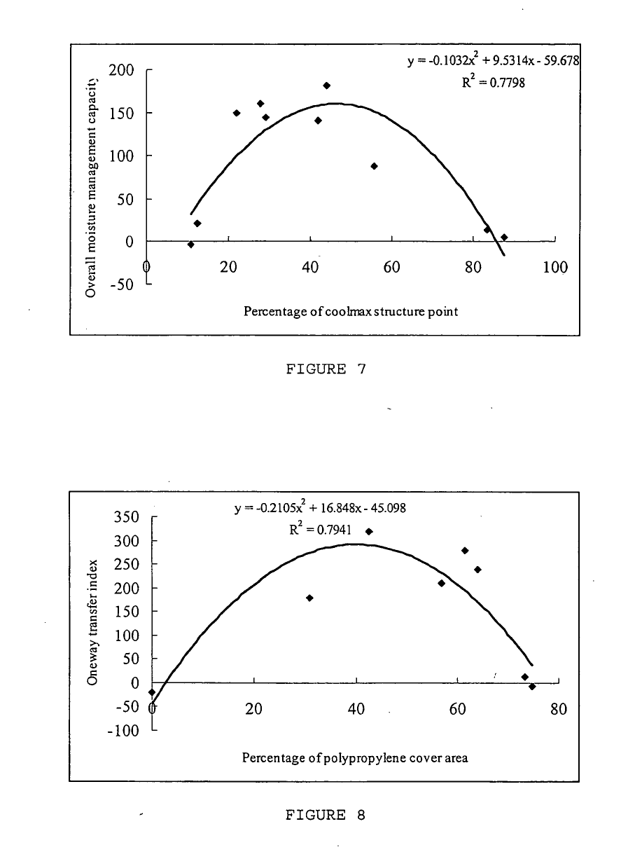

FIG. 7 shows the influence of percentage of inner surface structure point of coolmax on the fabric overall moisture management capacity.

FIG. 8 shows the influence of percentage of inner surface area of polypropylene on the fabric one-way transfer property.

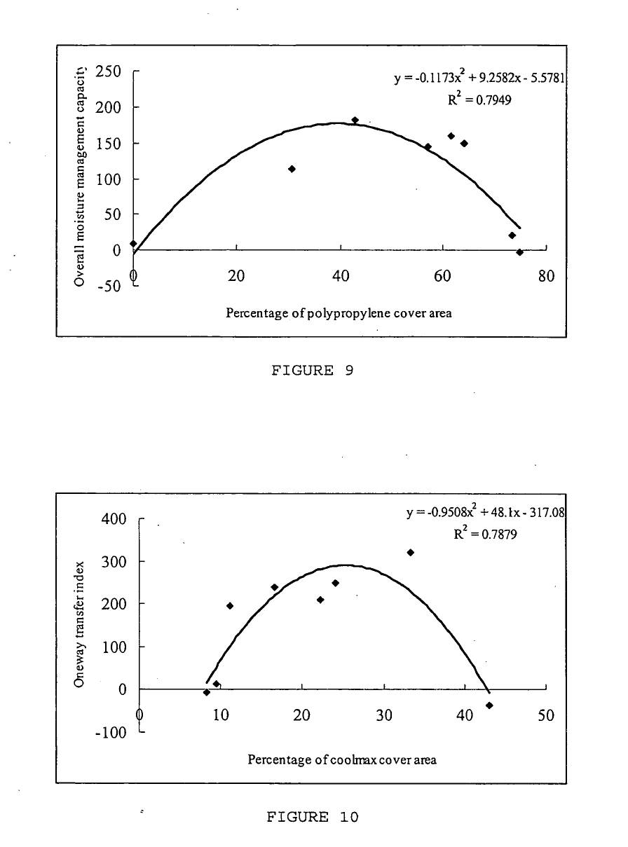

FIG. 9 shows the influence of percentage of inner surface area of polypropylene on the fabric overall moisture management capacity.

FIG. 10 shows the influence of percentage of inner surface area of coolmax on the fabric one-way transfer property.

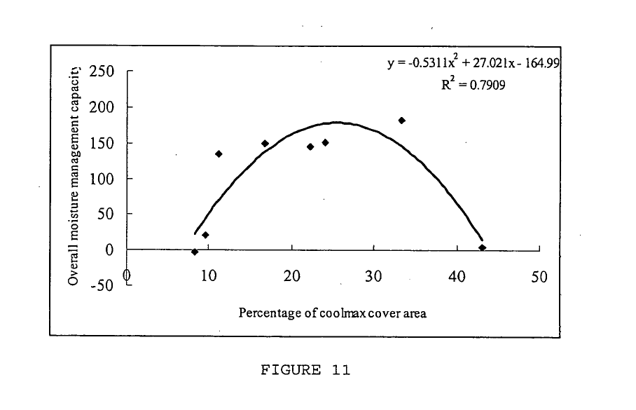

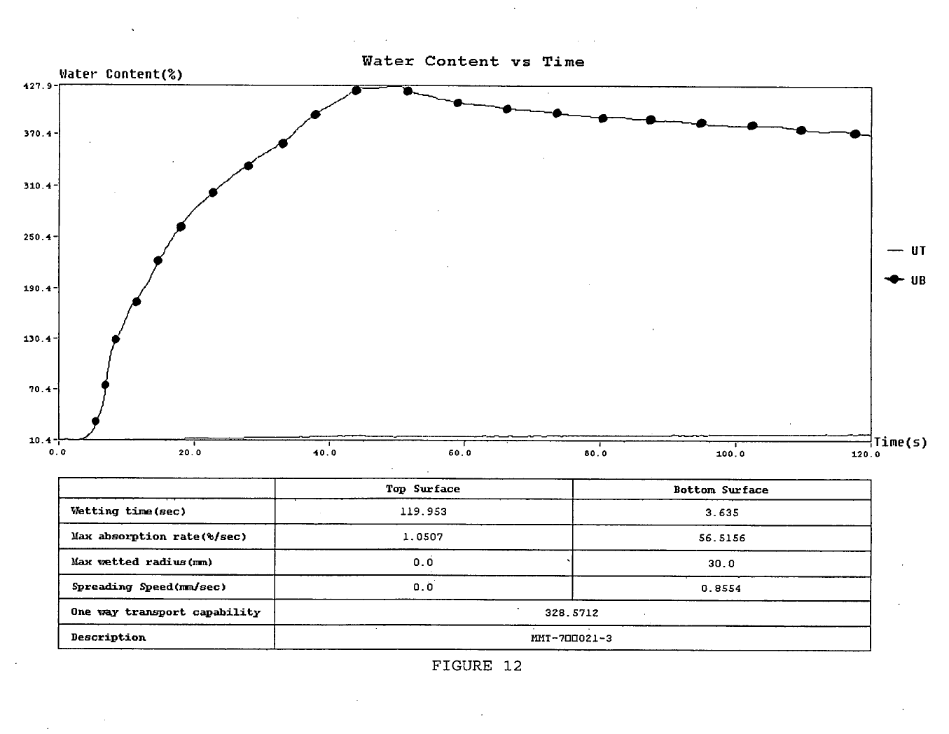

FIG. 11 shows the influence of percentage of inner surface area of coolmax on the fabric overall moisture management capacity.

In an alternative embodiment of the invention polypropylenes or coolmax is replaced by pure cotton yarns pre-treated by a nano water repellent agent as hydrophobic yarn. The typical measurement curve for this alternative embodiment is shown in FIG. 12.

The fabric according to the invention can more easily transport the liquid water from the inner surface to the outer surface than the normal fabrics, such as pure cotton fabric, and so maintain the comfort feeling during the wearing, especially under the heavy sweating rate.

Where in the foregoing description reference has been made to integers or elements having known equivalents then such are included as if individually set forth herein.

Embodiments of the invention have been described, however it is understood that variations, improvements or modifications can take place without departure from the spirit of the invention or scope of the appended claims.

1. A woven fabric comprising a generally uniform woven structure consisting of hydrophobic and hydrophilic materials, the woven structure having an inner exposed surface of hydrophobic and hydrophilic materials that is between 40% and 70% the hydrophobic material, and having an outer exposed surface of hydrophobic and hydrophilic materials that is predominantly the hydrophilic material.

2. The fabric of claim 1 wherein the hydrophobic material is a synthetic fibre with a hydrophobic property.

3. The fabric of claim 1 wherein the hydrophobic material is one of polypropylene and polyester.

4. The fabric of claim 1 wherein the hydrophobic material is a natural fiber selected from the group consisting of cotton, wool, silk, and linen, and treated with a water repellent agent.

5. The fabric of claim 4 wherein the water repellent agent is HYDROPHOBL CF.

6. The fabric of claim 4 wherein the water repellent agent is SiOₓ nano water repellent agent.

7. The fabric of claim 1 wherein the hydrophilic material is absorbent yarn made from synthetic fiber.

8. The fabric of claim 7 wherein the synthetic fiber is one of coolmax and coolplus.

9. The fabric of claim 1 wherein the hydrophilic material is absorbent yarn made from natural fiber.

10. The fabric of claim 9 wherein the natural fiber is selected from the group consisting of cotton, silk, wool, and linen.

11. The fabric of claim 9 wherein the natural fiber is treated with a hydrophilic finishing agent with nano particles for creating nanostructures.

12. The fabric of claim 1 wherein the woven fabric structure is one of plain weave, twill weave, and sateen weave.

13. An article of clothing including the fabric according to claim 1.

14. A diaper including the fabric according to claim 1.

15. A household article including the fabric according to claim 1.
